(19) United States
(12) Patent Application Publication
(10) Pub. No.: US 2023/0182038 A1
(43) Pub. Date: Jun. 15, 2023

(54) ASTATINE PURIFICATION METHOD

(71) Applicant: THE TEXAS A&M UNIVERSITY SYSTEM, College Station, TX (US)

(72) Inventors: Jonathan D. BURNS, College Station, TX (US); Evgeny E. TERESHATOV, College Station, TX (US); Lauren A. MCINTOSH, College Station, TX (US); Gabriel C. TABACARU, College Station, TX (US); Sherry J. YENNELLO, College Station, TX (US)

(21) Appl. No.: 17/995,145

(22) PCT Filed: Mar. 31, 2021
(86) PCT No.: PCT/US2021/025156

§ 371 Date: Sep. 30, 2022

Related U.S. Application Data
(60) Provisional application No. 63/003,335, filed on Apr. 1, 2020.

(51) Int. Cl. B01D 15/12; B01D 15/42; B01J 20/28; C01B 7/00

(52) U.S. Cl. CPC B01D 15/12; B01D 15/426; B01J 20/28026; C01B 7/00

(57) ABSTRACT

A process for isolating astatine includes (a) contacting a composition comprising astatine and bismuth with nitric acid to form a first solution comprising astatine, bismuth, and nitric acid; (b) contacting a resin with the first solution so that astatine partitions out of the first solution and into the resin; and (c) eluting astatine from the resin. A composition comprising astatine may be of the formula AtO⁺X⁻, wherein X⁻ is a counterion.

### CROSS-REFERENCE TO RELATED APPLICATIONS

This application claims priority under 35 U.S.C. § 119(e) to U.S. Provisional Application Ser. No. 63/003,335 filed on Apr. 1, 2020, the entire disclosure of which is incorporated herein by reference.

### GOVERNMENT RIGHTS

This invention was made with government support under DOE-Office of Science DE-SC0020958. The government has certain rights in the invention.

### BACKGROUND

Targeted alpha therapy (TAT) drugs have gained a large amount of interest following the success of Xofigo®, based on the α-emitting ²²³RaCl₂, in treating metastatic castration-resistant prostate cancer. The promising performance of Xofigo® has illustrated the need to expand the catalog of α-emitting radionuclides available for use. One such isotope which has drawn a great deal of attention is ²¹¹At, having well-suited decay properties for clinical settings, with a moderately-short half-life of 7.2 h and a quantitative α-emission from a simple decay scheme. With only roughly 30 cyclotrons possessing the ability to generate usable quantities world-wide and just seven of them in the US, only one of which is currently a supplier for the US Department of Energy's Isotope Program, the supply of ²¹¹At remains limited. Bombardment of natural Bi targets with an α-particle beam in the energy range of 28.5-31 MeV has been adopted as the standard for generating usable quantities of ²¹¹At via the ²⁰⁹Bi(α,2n)²¹¹At nuclear reaction. Despite the low availability, ²¹¹At has been used in a number of clinical trials investigating the treatment of malignant brain tumors, ovarian cancer, and a current study treating advanced hematopoietic malignancies.

In addition, At chemistry in general is one of the few areas left relatively unexplored on the periodic table. This can be attributed to the fact that At's abundance on earth is estimated to be only 0.07 g, the lowest of any naturally occurring element, because At has no stable isotopes. The longest half-life of only ˜8.1 h belongs to ²¹⁰At, slightly longer lived than ²¹¹At. Astatine is the fifth member of the halogen series and the heaviest confirmed member of the metalloids, which allows for a rich and diverse chemistry. As an example, various oxidation states have been observed, At⁻, At⁰, At⁺, At³⁺, At⁵⁺, and At⁷⁺, but a detailed description of their chemistry and speciation has been inhibited by the barrier surrounding its limited supply. The electronic structure, complicated by relativistic effects of this large (atomic radius ˜0.45 Å), heavy element (Z=85), undergoes significant spin-orbit-coupling, making predictions of its chemical behavior based on computational models which neglect spin-orbit-coupling problematic. Conversely, including spin-orbit-coupling requires significantly more computational resources and specialized treatment of the models to ensure accuracy of the predictions. Numerous properties of At and its complexes are affected by the inclusion of spin-orbit-coupling in such predictions, which include polarizability, electronegativity, shifts in the vibrational frequency, and changes in the dipole moment, to name a few.

Whether motivated by exploring the frontiers of the periodic table, radiopharmaceutical applications, or understanding At in its own right, a rapid and efficient separation and purification for recovery and isolation of this interesting element is of crucial importance. Historically, two approaches have been utilized to recover ²¹¹At from the Bi targets: dry distillation and wet chemical processing. The latter has been shown to generate a more reproducible ²¹¹At recovery yield. For an analytical scale separation, where the amount of ²¹¹At to be recovered and purified is on the order of 1-10 ng, with macro amounts of Bi (1-10 g) making up the bulk of the matrix, solvent extraction does not lend itself as an efficient means for separation, as it is limited to a single separation stage per contact and requires sophisticated equipment to run in a continuous-flow mode. Chromatography, conversely, can provide a large number of stages in a single column and is inherently run in a continuous-flow mode.

Both Woen et al. (Inorg. Chem. 59 (2020) 6137-6146) and Li et al. (Sci. Rep. 9 (2019) 16960) have recently shown effective chromatography systems for recovering ²¹¹At from bombarded ²⁰⁹Bi targets, with yields of 68% using Pre-Filter resin and 95% using tellurium metal powder, respectively. US 2018/0308599 also describes a process of isolating ²¹¹At using chromatography. However, these approaches require the system to be converted from a nitrate to a chloride media, which adds a slow, time-consuming step of either evaporation to dryness to remove the nitrate or the approaches require chemical destruction of the nitrate with hydroxylammonium chloride. Thus, a rapid process and more efficient process to recover At is desirable.

### SUMMARY

According to one aspect of the present disclosure, a process comprises:

(a) contacting a composition comprising astatine and bismuth with nitric acid to form a first solution comprising astatine, bismuth, and nitric acid;

(b) contacting a resin with the first solution so that astatine partitions out of the first solution and into the resin; and

(c) eluting astatine from the resin.

In another aspect, a composition comprises AtO⁺X⁻, wherein X is a counterion.

Additional embodiments, features, and advantages of the disclosure will be apparent from the following detailed description and through practice of the disclosure. The process and compounds of the present disclosure can be described as embodiments in any of the following enumerated clauses. It will be understood that any of the embodiments described herein can be used in connection with any other embodiments described herein to the extent that the embodiments do not contradict one another.

1. A process comprising

(a) contacting a composition comprising astatine and bismuth with nitric acid to form a first solution comprising astatine, bismuth, and nitric acid;

(b) contacting a resin with the first solution so that astatine partitions out of the first solution and into the resin; and

(c) eluting astatine from the resin.

2. The process of clause 1, wherein the resin is impregnated with a solvent.

3. The process of clause 1 or 2, wherein the solvent comprises an organic solvent.

4. The process of any one of the preceding clauses, wherein the organic solvent is polar.

5. The process of any one of the preceding clauses, wherein the organic solvent comprises an optionally substituted C₁-C₁₈ alkyl.

6. The process of any one of the preceding clauses, wherein the organic solvent comprises a carbonyl.

7. The process of any one of the preceding clauses, wherein the organic solvent comprises an aldehyde, a ketone, an ester, an amide, a carbonate, a carboxylate, or a carbamate.

8. The process of any one of the preceding clauses, wherein the organic solvent is of the formula C₁-C₆ alkyl-C(O)—C₁-C₆ alkyl, wherein each hydrogen atom in C₁-C₆ alkyl is optionally substituted.

9. The process of any one of the preceding clauses, wherein the organic solvent is octanone.

10. The process of any one of the preceding clauses, wherein the organic solvent is 3-octanone.

11. The process of any one of clauses 1-5, wherein the organic solvent is a C₁-C₁₈ alkanol.

12. The process of any one of the preceding clauses, wherein the astatine has a D-value partition coefficient in the organic solvent of at least 20.

13. The process of any one of the preceding clauses, wherein the astatine has a D-value partition coefficient in the organic solvent at least 40.

14. The process of any one of the preceding clauses, wherein the astatine has a D-value partition coefficient in the organic solvent at least 60.

15. The process of any one of the preceding clauses, wherein the astatine has a D-value partition coefficient in the organic solvent at least 80.

16. The process of any one of the preceding clauses, wherein the resin is an inert resin.

17. The process of any one of the preceding clauses, wherein the resin is a polymeric resin, a zeolite, a molecular sieve, or a porous glass bead.

18. The process of any one of the preceding clauses, wherein the resin comprises a styrene-divinylbenzene copolymer.

19. The process of clause 18, wherein the benzene does not contain a functional group.

20. The process of any one of the preceding clauses, wherein the astatine is ²¹¹At.

21. The process of any one of the preceding clauses, wherein the astatine is ²⁰⁹At.

22. The process of any one of the preceding clauses, wherein the bismuth does not partition into the resin.

23. The process of any one of the preceding clauses, wherein the nitric acid in the first solution is at a concentration of about 1 M to about 10 M.

24. The process of any one of the preceding clauses, wherein the nitric acid in the first solution is at a concentration of about 1 M to about 8 M.

25. The process of any one of the preceding clauses, wherein the nitric acid in the first solution is at a concentration of about 2 M to about 8 M.

26. The process of any one of the preceding clauses, wherein the process further comprises the step of washing the resin after step (b).

27. The process of any one of the preceding clauses, wherein the step of washing is performed by passing an aqueous solution through the resin.

28. The process of clause 27, wherein the aqueous solution comprises an acid.

29. The process of clause 28, wherein the acid is nitric acid, hydrobromic acid, hydrochloric acid, sulfuric acid, or perchloric acid.

30. The process of clause 28 or 29, wherein the concentration of acid is about 1 M to about 10 M.

31. The process of any one of the preceding clauses, wherein the process recovers ≥85% of the astatine from the mixture

32. The process of any one of the preceding clauses, wherein the process recovers ≥90% of the astatine from the mixture.

33. The process of any one of the preceding clauses, wherein the process recovers ≥95% of the astatine from the mixture.

34. The process of any one of the preceding clauses, wherein the astatine after step (c) has a purity of ≥90%.

35. The process of any one of the preceding clauses, wherein the astatine after step (c) has a purity of ≥95%.

36. The process of any one of the preceding clauses, wherein the astatine after step (c) has a purity of ≥99%.

37. The process of any one of the preceding clauses, wherein the step of eluting is performed by contacting the resin with a second organic solvent.

38. The process of clause 37, wherein the second organic solvent comprises acetone or a C₁-C₁₈ alkanol.

39. The process of clause 38, wherein the second organic solvent comprises ethanol.

40. The process of any one of clauses 37-39, wherein the second organic solvent is miscible in the first organic solvent.

41. The process of any one of the preceding clauses, wherein steps (a), (b), and (c) are performed in less than about 1 hour.

42. The process of any one of the preceding clauses, wherein steps (a), (b), and (c) are performed in less than about 30 minutes.

43. The process of any one of the preceding clauses, wherein steps (a), (b), and (c) are performed in less than about 15 minutes.

44. The process of any one of the preceding clauses, wherein steps (a), (b), and (c) are performed in less than about 10 minutes.

45. The process of any one of the preceding clauses, wherein steps (a), (b), and (c) are performed in less than about 20% of the half-life of the astatine.

46. The process of any one of the preceding clauses, wherein steps (a), (b), and (c) are performed in less than about 15% of the half-life of the astatine.

47. The process of any one of the preceding clauses, wherein steps (a), (b), and (c) are performed in less than about 10% of the half-life of the astatine.

48. The process of any one of the preceding clauses, wherein steps (a), (b), and (c) are performed in less than about 5% of the half-life of the astatine.

49. The process of any one of the preceding clauses, wherein the process includes a step of preparing the resin prior to step (b).

50. The process of clause 49, wherein the step of preparing the resin includes contacting the resin with an organic solvent.

51. The process of any one of the preceding clauses, wherein the process further comprises a step of labeling a therapeutic with the eluted astatine.

52. A composition comprising AtO⁺X⁻, wherein X⁻ is a counterion.

53. The composition of clause 52, wherein X⁻ is nitrate, a halide, or perchlorate.

54. The composition of clause 53, wherein X⁻ is nitrate.

55. The composition of clause 53, wherein X⁻ is perchlorate.

56. The composition of clause 53, wherein X⁻ is a halide.

57. The composition of clause 56, wherein the halide is chloride.

58. The composition of any one of clauses 52-57, wherein the composition is complexed with an organic solvent.

59. The composition of clause 58, wherein the organic solvent comprises an optionally substituted C₁-C₁₈ alkyl.

60. The composition of clause 58, wherein the organic solvent comprises a carbonyl.

61. The composition of clause 58, wherein the organic solvent comprises an aldehyde, a ketone, an ester, an amide, a carbonate, a carboxylate, or a carbamate.

62. The composition of clause 58, wherein the organic solvent is of the formula C₁-C₆ alkyl-C(O)—C₁-C₆ alkyl, wherein each hydrogen atom in C₁-C₆ alkyl is optionally substituted.

63. The composition of clause 58, wherein the organic solvent is octanone.

64. The composition of clause 58, wherein the organic solvent is 3-octanone.

65. The composition of any one of clauses 52-64, wherein the astatine is ²¹¹At.

66. The composition of any one of clauses 52-64, wherein the astatine is ²⁰⁹At.

67. The composition of any one of clauses 52-66, produced by a process according to any one of clauses 1-51.

68. A composition comprising astatine produced by a process according to any one of clauses 1-51.

69. A process consisting of the steps of any one of clauses 1-51.

70. A process consisting essentially of the steps of any one of clauses 1-51.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

FIG. 1 shows D-values of the extraction of ²¹¹At into different organic solvents as a function of initial aqueous HNO₃ concentration. Solid lines for visual aid. Note D-values for Bi were ≤0.05 in all cases.

FIG. 2 shows a TGA curve of Amberchrom® CG300M resin before (blue) and impregnated with 1-octanol and 3-octanone).

FIG. 3 shows the amount of 3-octanone leached (▪) and percent of total leached (♦) into collected fractions from a 3-octanone impregnated Amberchrom® CG300M resin bed (0.5-mL BV, 7 mm ID×13 mm height) calculated from TOC analysis. Arrows indicate the corresponding axis for each data set.

FIG. 4 shows a chromatogram of a 0.5-mL aliquot of 2 M HNO₃ containing a 20-μL spike (˜13 μCi ²¹¹At) of Run 1 dissolved bombarded target solution with a 1-octanol impregnated Amberchrom® CG300M resin bed (0.5-mL BV, 7 mm ID×13 mm height). Note: data were decay corrected to account for differences in half-lives; Bi was determined by ICP-MS.

FIG. 5 shows a chromatogram of a 0.5-mL aliquot of 2 M HNO₃ containing a 20-μL spike (˜13 μCi ²¹¹At) of the Run 1 dissolved bombarded target solution with a 3-octanone impregnated Amberchrom® CG300M resin bed (0.5-mL BV, 7 mm ID×13 mm height). Note: data were decay corrected to account for differences in half-lives; Bi was determined by ICP-MS.

FIG. 6 shows a chromatogram of a 0.5-mL aliquot of 6 M HNO₃ containing a 20-μL spike (˜13 μCi ²¹¹At) of the Run 1 dissolved bombarded target solution with a 3-octanone impregnated Amberchrom® CG300M resin bed (0.5-mL BV, 7 mm ID×13 mm height). Note: data were decay corrected to account for differences in half-lives; Bi was determined by ICP-MS.

FIG. 7 shows a chromatogram of a 1.5-mL aliquot of 2 M HNO₃ containing a 399-μL spike (˜1.0 mCi ²¹¹At) of the Run 2 dissolved bombarded target and a 42-μL spike of ²⁰⁷Bi (˜10 nCi) with a 3-octanone impregnated Amberchrom® CG300M resin bed (0.5-mL BV, 7 mm ID×13 mm height). Note: the dead volume was assumed to be half the BV, but appears to have been an over estimate, as a small amount of ²⁰⁷Bi and ^{66/67}Ga was observed in the fraction; data were decay corrected to account for differences in half-lives.

FIG. 8 shows a chromatogram of a 1.4-mL aliquot of 4 M HNO₃ containing a 399-μL spike (˜1.0 mCi ²¹¹At) of the Run 2 dissolved bombarded target and a 42-μL spike of ²⁰⁷Bi (˜10 nCi) solution with a 3-octanone impregnated Amberchrom® CG300M resin bed (0.5-mL BV, 7 mm ID×13 mm height). Note: the dead volume was assumed to be half the BV, but appears to have been an over estimate, as a small amount of ²⁰⁷Bi and ^{66/67}Ga was observed in the fraction; data were decay corrected to account for differences in half-lives.

FIG. 9 shows a chromatogram of a 1.3-mL aliquot of 5.7 M HNO₃ containing a 399-μL spike (˜1.0 mCi ²¹¹At) of the Run 2 dissolved bombarded target solution and a 42-μL spike of ²⁰⁷Bi (˜10 nCi) with a 3-octanone impregnated Amberchrom® CG300M resin bed (0.5-mL BV, 7 mm ID×13 mm height). Note: the dead volume was assumed to be half the BV, but appears to have been an over estimate, as a small amount of ²⁰⁷Bi and ^{66/67}Ga was observed in the fraction; data were decay corrected to account for differences in half-lives.

FIG. 10 shows a chromatogram of a 5-mL aliquot of the Run 1 dissolved bombarded target solution (4.1 mCi ²¹¹At in ˜6 M HNO₃) with a 3-octanone impregnated Amberchrom® CG300M resin bed (0.5-mL BV, 7 mm ID×13 mm height). Note: data were decay corrected to account for differences in half-lives; Bi was determined by ICP-MS.

FIG. 11 shows a chromatogram of a 4-mL aliquot of 5.9 M HNO₃ containing a 3.76-mL spike (˜9.8 mCi ²¹¹At) of the Run 2 dissolved bombarded target solution and a 240 μL spike of ²⁰⁷Bi (˜57.6 nCi) with a 3-octanone impregnated Amberchrom® CG300M resin bed (0.5-mL BV, 7 mm ID×13 mm height). Note: the dead volume was assumed to be half the BV, but appears to have been an over estimate, as a small amount of ²⁰⁷Bi and ^{66/67}Ga was observed in the fraction; data were decay corrected to account for differences in half-lives.

### DETAILED DESCRIPTION

Astatine (At) may be useful as a radiolabel for therapeutics. However, the natural abundance of At is low. At may be produced by bombarding a bismuth (Bi) metal target with alpha-particles. The produced At must be subsequently isolated from unreacted Bi. Described herein is a process that isolates At from compositions, such as the composition formed from bombarding Bi, using chromatography. In illustrative embodiments, the process described herein dissolves a composition comprising At and subsequently isolates the At from the dissolved mixture. The described process can be performed without the need to convert the media or solution used to initially dissolve the At/Bi composition.

The At described herein may be ²⁰⁹At or ²¹¹At and cationic species thereof. For example, the At described in the process herein may be the cationic species AtO⁺ but will still be referred to as At. Illustratively, the process may include producing the At. The At may be produced by the ²⁰⁹Bi(α,2n)²¹¹At nuclear reaction whereby ²⁰⁹Bi metal is bombarded with α-particle. The formed bombarded target may comprise a mixture of At, unreacted Bi, and byproducts.

In some aspects, the At is isolated from the composition comprising Bi and At. Illustratively, the composition is contacted with a solution such as an aqueous solution. In illustrative aspects, the aqueous solution comprises an acid, for example an organic acid or a mineral acid. The mineral acid may be nitric acid. The solution dissolves or substantially dissolves the composition to form a solution comprising At and Bi. In some embodiments, the solution comprises At, Bi, and an acid. In some embodiments, the solution comprises At, Bi, and nitric acid.

In some aspects, the solution has a particular concentration of acid or is adjusted prior to subsequent steps to have a particular concentration of acid. Illustratively, the acid may assist in dissolving the composition. For example, the presence of nitric acid may aid in dissolving a bombarded Bi target.

Illustratively, the acid concentration may be about 1 M to about 10 M, about 1 M to about 8 M, about 2 M to about 8 M, or about 3 M to about 7 M. The concentration of acid may be about 1 M, about 2 M, about 3 M, about 4 M, about 5 M, about 6 M, about 7 M, about 8 M, about 9 M, or about 10 M. The concentration of acid maybe adjusted depending on the partition coefficient in a solvent used in subsequent steps. The ranges described herein are equally applicable when the acid is an organic acid or a mineral acid such as nitric acid.

In some aspects, the At is isolated using chromatography. In illustrative embodiments, the chromatography is performed by using a resin. The resin may be in the form of a resin bed. The resin bed may be in a column. Alternatively, the resin may be used in a bulk process. Illustrative resins include polymeric resins and glass resins. In some embodiments, the resin comprises a zeolite, a molecular sieve, a polymeric resin, or a glass resin. In some embodiments, the resin is porous. In some embodiments, the porous resin is a poly-acrylate resin or a porous glass bead. The resin may be inert. In some embodiments, the resin comprises a styrene-divinylbenzene copolymer. In some embodiments, the benzene of the copolymer does not contain a functional group.

In some aspects, the process includes a step of preparing the resin. This step may occur prior to contacting the resin with a solution comprising At. In illustrative embodiments, the resin may be contacted with a solvent, such as an organic solvent. Illustratively, the step of preparing the resin yields a resin impregnated with a solvent, such as an organic solvent. In some embodiments, the organic solvent is polar. In some embodiments, the organic solvent comprises an optionally substituted C₁-C₁₈ alkyl where each hydrogen atom of the C₁-C₁₈ alkyl is optionally substituted by a functional group. Optional substituents on C₁-C₁₈ alkyl are commonly known in the art and include halogens, hydroxyls, amines, thiols, oxo, ketones, carboxylates, aldehydes, amides, carbonates, carbamates, combinations thereof, and the like. In some embodiments, the organic solvent comprises an aldehyde, a ketone, an ester, an amide, a carbonate, a carboxylate, or a carbamate. In some embodiments, the organic solvent comprises a C₁-C₁₈, C₁-C₁₂, or C₁-C₆ alkyl comprising an aldehyde, a ketone, an ester, an amide, a carbonate, a carboxylate, or a carbamate. In some embodiments, the organic solvent is of the formula C₁-C₆ alkyl-C(O)—C₁-C₆ alkyl. In some embodiments, the organic solvent is of the formula C₁-C₆ alkyl-C(O)—C₁-C₆ alkyl, wherein each hydrogen atom in C₁-C₆ alkyl is optionally substituted. In some embodiments, the organic solvent is octanone. In some embodiments, the organic solvent is 3-octanone. In some embodiments, the organic solvent is a C₁-C₁₈ alkanol. Illustratively, the organic solvent may comprise a mixture of the organic solvents described herein.

The term “alkyl” refers to a straight- or branched-chain monovalent hydrocarbon group. In some embodiments, it can be advantageous to limit the number of atoms in an “alkyl” to a specific range of atoms, such as C₁-C₁₈ alkyl, C₁-C₁₂, alkyl, or C₁-C₆ alkyl. Examples of alkyl groups include methyl (Me), ethyl (Et), n-propyl, isopropyl, butyl, isobutyl, sec-butyl, tert-butyl (tBu), pentyl, isopentyl, tert-pentyl, hexyl, isohexyl, and groups that in light of the ordinary skill in the art and the teachings provided herein would be considered equivalent to any one of the foregoing examples. It will be appreciated that an alkyl group can be unsubstituted or substituted as described herein. An alkyl group can be substituted with any of the substituents in the various embodiments described herein, including one or more of such substituents. The term “alk-” may form a prefix with the remainder being a functional group. For example an “alkanol” is an alkyl group substituted with an alcohol.

The term “substituted” means that the specified group or moiety bears one or more substituents. The term “unsubstituted” means that the specified group bears no substituents. Where the term “substituted” is used to describe a structural system, the substitution is meant to occur at any valency-allowed position on the system. In some embodiments, “substituted” means that the specified group or moiety bears one, two, or three substituents. For example, two hydrogen atoms on a carbon of an alkyl group may be substituted by an oxo (═O) group to form carbonyl (C═O). In other embodiments, “substituted” means that the specified group or moiety bears one or two substituents. In still other embodiments, “substituted” means the specified group or moiety bears one substituent.

The term “halogen” or “halo” represents chlorine, fluorine, bromine, or iodine.

In some aspects, the solvent of the impregnated resin is a solvent that provides a D-value partition coefficient for At of at least 10 against an aqueous solution, such as an aqueous solution comprising nitric acid. In illustrative embodiments, At has a D-value partition coefficient in the organic solvent of at least about 20, at least about 40, at least about 60, or at least about 80. Illustratively, the partition coefficient may be measured against an aqueous solution comprising an acid, such as nitric acid. In some embodiments, At has a partition coefficient of at least about 20 or at least about 40 between octanone and an aqueous solution comprising about 2-6 M nitric acid.

In some embodiments, the At composition is loaded onto a resin in a volume of a solution in a ratio to the volume of the resin bed volumes. In some embodiments, the solution comprising At is loaded onto the resin bed at a ratio of up to about 10, up to about 8, up to about 6, or up to about 4 bed volumes. The number of bed volumes used to load the At composition may adjusted by means known within the art to maximize the amount of At partitioned into the resin.

Illustratively, the At may contact a resin and the At may partition into the resin, form a complex, or otherwise form a favorably interaction with the resin. Illustratively, although Bi may contact the resin, Bi will not be retained in or on the resin. Alternatively, the Bi may form weak interactions with the resin such that bound or retained Bi is removed when washing the resin. It should be understood that contact includes any manner of chemical interactions such as ionic or non-covalent interactions. It should be further understood that partitioning into the resin includes partitioning into an interior space of the resin as well as contacting the surface of the resin and forming a favorable interaction to retain the At to the resin.

After the step of contacting with the solution containing a mixture comprising At, the resin may be washed. The step of washing may include washing the resin with an aqueous solution. In some embodiments, the aqueous solution comprises an acid. In some embodiments, the aqueous wash solution comprises an acid at a lower concentration than the acid concentration used to dissolve the At/Bi composition. For example, if the acid concentration is about 6 M in the aqueous solution that dissolves the At/Bi composition, the acid concentration in the wash solution may be less than about 6 M, for example about 2 M. In some embodiments, the concentration of acid is less than about 10 M, less than about 8 M, less than about 6 M, or less than about 4 M. In some embodiments, the concentration of acid is up to about 8 M, up to about 6 M, or up to about 4 M. In illustrative embodiments, the acid used in the wash steps is the same acid, for example nitric acid, as the acid in the previous steps.

Alternatively, the acid may be a different acid. For example, the acid may be HClO₄, HCl, HBr, or H₂SO₄. Illustratively, changing the acid used in the wash step may change the counterion of the isolated At recovered by the eluting step.

In some embodiments, the step of washing the resin is measured as ratio of bed volumes. For example, the resin may be washed with a solution having a volume of at least about 2, at least about 3, at least about 4, at least about 5, or at least about 6 bed volumes. In illustrative embodiments, the resin may be washed sequentially with an aqueous solution containing an acid and an aqueous solution free of an acid. The washing steps may be adjusted by means known in the art to include additional or fewer washing steps of aqueous solutions.

The process includes a step of eluting the At from the resin. Illustratively, the step of eluting dissociates the At from the resin to allow for the At to be collected. The eluting step may be performed by contacting the resin with an organic solvent. In some embodiments, the organic solvent is the same solvent that impregnates the resin. In some embodiments, the organic solvent in the eluting step is miscible with the solvent that impregnates the resin. In some embodiments, the organic solvent comprises an optionally substituted C₁-C₁₈ alkyl where each hydrogen atom of the C₁-C₁₈ alkyl is optionally substituted by a functional group. Optional substituents on C₁-C₁₈ alkyl are commonly known in the art and include halogens, hydroxyls, amines, thiols, oxo, ketones, carboxylates, aldehydes, amides, carbonates, carbamates, combinations thereof, and the like. In some embodiments, the organic solvent comprises an aldehyde, a ketone, an ester, an amide, a carbonate, a carboxylate, or a carbamate. In some embodiments, the organic solvent comprises a C₁-C₁₈, C₁-C₁₂, or C₁-C₆ alkyl comprising an aldehyde, a ketone, an ester, an amide, a carbonate, a carboxylate, or a carbamate. In some embodiments, the organic solvent is of the formula C₁-C₆ alkyl-C(O)—C₁-C₆ alkyl. In some embodiments, the organic solvent is of the formula C₁-C₆ alkyl-C(O)—C₁-C₆ alkyl, wherein each hydrogen atom in C₁-C₆ alkyl is optionally substituted. In some embodiments, the organic solvent is octanone. In some embodiments, the organic solvent is 3-octanone. In some embodiments, the organic solvent is a C₁-C₁₈ alkanol. In some embodiments, the solvent comprises ethanol.

Illustratively, the process described herein recovers at least about 80%, at least about 85%, at least about 90%, or at least about 95% of the At from the composition comprising At. In some embodiments, the process recovers about 80% to about 99%, about 85% to about 99%, or about 90% to about 99% of the At from the composition comprising At.

Illustratively, the eluted At has a purity higher for At than the composition comprising At prior to the chromatograph step. In some embodiments, the eluted At has a purity of at least about 90%, at least about 95%, or at least about 99%.

The process described herein may be performed in less than about 1 hour, less than about 30 minutes, less than about 15 minutes, or less than about 10 minutes. Illustratively, the process is performed in less time compared to a comparative process that requires a step of dissolving an At/Bi composition in an nitric acid solution, evaporating the nitric acid solution, and reconstituting the residue in hydrochloric acid prior to chromatography or compared to a comparative process that requires destruction of t nitrate prior to chromatography. The process described herein isolates At in a particular percentage of its half-life. In some embodiments, the process is performed in less than about 20%, less than about 15%, less than about 10%, or less than about 5% of the half-life of At such as ²¹¹At.

In some embodiments, the process may further include labeling a therapeutic with the eluted At. This may be done directly with the column fraction of eluted At or may include concentrating the fraction containing At and suspending or dissolving the At in a solution used for the labeling step.

In another aspect, a composition comprises the salt AtO⁺X⁻, wherein X⁻ is a counterion. The counter ion may be the conjugate base of an aqueous acid used in the process described herein or may be the conjugate base of any suitable acid. In some embodiments, X⁻ is nitrate, a halide, or perchlorate. In some embodiments, X⁻ is nitrate. In some embodiments, X⁻ is a halide. Suitable halides include fluorides, chlorides, or bromides. In some embodiments, X⁻ is perchlorate. In some embodiments, the At of AtO⁺ is ²¹¹At or ²⁰⁹At.

### Examples

Materials:

Nitric Acid (67-70% Aristar® Plus, HNO₃) was purchased from BDH chemicals; 3-octanone (ACS Grade ≥96%) was purchased from EMD Millipore Corp.; 1-octanol (Lab grade) was purchased from Ward's Science; and ethanol (≥99.5% 200 proof) was purchased from EMD, and all were used as received. Deionized (DI) H₂O was obtained from an ELGA LabWater Purelab Flex ultrapure laboratory water purification system operated at 18.2 MΩ cm at 25° C.

Bismuth-207 was purchased from Eckert & Ziegler Isotope Products (Valencia, Calif.) as a Bi(NO₃)₃ solution with ˜0.24 μCi per mL and roughly 48 μM total Bi concentration in 4 M HNO₃.

Methods:

Quantitative analysis for Bi was performed utilizing inductively-coupled plasma mass spectrometry (ICP-MS) with a Thermo Fisher Scientific iCAP RQ mass spectrometer. Semi-quantitative analysis of ²⁰⁷Bi and quantitative analysis for ²¹¹At was performed via gamma (γ)-ray spectroscopy using a calibrated Canberra Model GC2020 high-purity germanium detector (HPGe) with a relative efficiency of 20.0% and an active detector volume of ˜115 cm³ and InSpector™ 2000 digital signal analyzer (DSA, Canberra Industries Inc., Meriden, Conn.) along with Genie-2000 software. The detector has an energy resolution of 1.0 keV at 122 keV and 1.98 keV at 1300 keV. Relevant nuclear data were obtained from Browne and Firestone. All calibrations were determined with a ¹⁵²Eu standard γ-ray source traceable to the National Institute of Standards and Technology (NIST) purchased from Eckert & Ziegler Isotope Products. The ²⁰⁷ Bi was tracked directly using the 1064 keV γ-ray. The ²¹¹At was tracked directly using the 76.9 keV, 79.9 keV, 89.8 keV, and 92.3 keV X-rays and 687 keV γ-ray. The impurities, ⁶⁶¹⁶⁷Ga, were identified by half-life analysis (see SI) and were tracked directly using the 833 keV and 1039 keV γ-rays for ⁶⁶Ga and the 185 keV and 300 keV γ-rays for ⁶⁷Ga.

At-211 Production:

Astatine-211 was produced in two separate runs by the ²⁰⁹Bi(α,2n)²¹¹At nuclear reaction via 28.8 MeV α-particle bombardment (˜0.9 barn cross section)[7] of a natural Bi metal target (isotopically pure ²⁰⁹Bi, metal purity ≥99.997% purchased from Goodfellow) for 9-10 h with an average beam current of 2.4-3.2 pμA on the K150 cyclotron at Texas A&M. The Bi metal targets were about 9.4 g or 1.0 g in mass with a racetrack oval shape (6.985×1.27 cm), capped with half circles (radii 0.635 cm) on either end with an estimated thickness of 950 μm or 100 μm, which was housed in an aluminum frame (6061 Al alloy, 95% Al) in contact with a support block cooled by recirculated water chilled to 15° C. The target was held at a 10° angle from the beam to maximize coverage of the target, while minimizing the loss of beam to the Al housing. The bombarded targets were dissolved in either 11.2 M or 8 M HNO₃, resulting in final HNO₃ concentration of roughly 6 M. This solution was then sampled and the production yield was determined for ²¹¹At at the end of bombardment. ²¹¹At and ²⁰⁷Bi to a lesser extent, are highly radioactive and were handled under ALARA principles in laboratories equipped to handle radioactive materials appropriately, a radiological biosafety cabinet was employed.

Partitioning

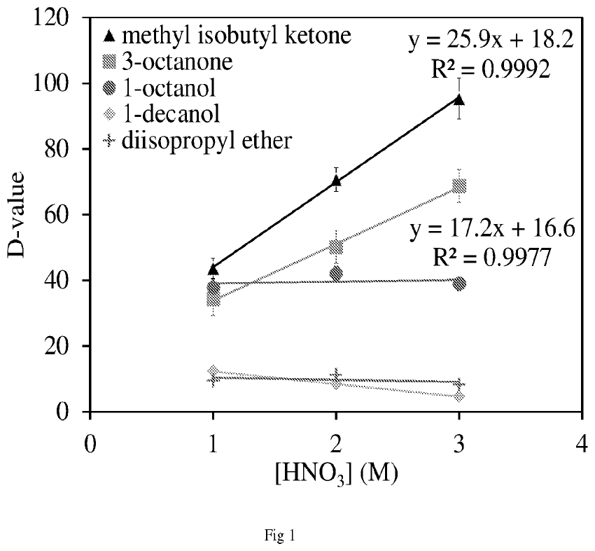

A series of extractions from HNO₃ at various concentrations into several organic solvents were investigated. First, simple straight-chain alcohols, 1-octanol and 1-decanol, were used to extract ²¹¹At from 1-3 M HNO₃, as shown in FIG. 1. The extraction of ²¹¹At into 1-octanol yielded distribution ratio (D) values of roughly 37.9±2.3, 42.0±2.2, and 38.9±2.1 at HNO₃ concentrations of 1, 2, and 3 M, respectively. Thus, the maximum extraction occurring around 2 M HNO₃. Conversely, the D-values for ²⁰⁷Bi into 1-octanol were ≤0.05 for all three acidities, which corresponds to all the activity being present in the aqueous phase, while the amount of ²⁰⁷Bi was below the detection limit in the organic phase. Increasing the aliphatic chain-length from C₈ to C₁₀ negatively impacted the extraction of ²¹¹At, with D-values of 12.3±0.8 in 1 M HNO₃, 8.4±0.4 in 2 M HNO₃, and 4.6±0.2 in 3 M HNO₃, reducing the extractability by a factor of roughly 3, 5, and 9-fold, respectively. Additionally, the maximum extraction into 1-decanol appears to occur ≤1 M HNO₃, as the decrease in D-value is linear as the HNO₃ concentration is increased from 1 to 3 M. The D-values for ²⁰⁷Bi were ≤0.05 into 1-decanol. While the exact mechanism of metal extraction along with the HNO₃ is still unknown, it seems the more non-polar nature of 1-decanol inhibits extraction. This may be a result originating from the requirement of maintaining charge balance and co-extraction of the nitrate counter anion into the organic phase along with the cationic At species. Assuming At(III) the AtO⁺ molecular cation is the extracted species, the following equilibrium describes the extraction:

AtO⁺+NO₃⁻ [symbol] A̅t̅O̅(̅N̅O̅₃̅)̅ (1)

To test this further, a less polar solvent, diisopropyl ether, and a more polar solvent, methyl isobutyl ketone, were investigated. The ²¹¹At extraction into diisopropyl ether was in the range of the 1-decanol, with the ²⁰⁷Bi continuing to remain in the aqueous phase (D-value ≤0.05). ²¹¹At behaved significantly different in the methyl isobutyl ketone system compared to the other solvent systems studied, displaying a strong HNO₃ dependence. The ²¹¹At extraction into methyl isobutyl ketone was slightly higher from that of 1-octanol in 1 M HNO₃, while the D-values increase by a factor of roughly 1.7× and 2.4× when the HNO₃ concentration is increased to 2 and 3 M, respectively. The ²⁰⁷Bi, on the other hand, showed similar behavior as the other systems studied, with very low D-values, ≤0.05. A second ketone, 3-octanone, with a polarity similar to 1-octanol was then tested to determine if solvation effects of the more polar methyl isobutyl ketone was the driving force for the extraction or if the carbonyl functional group of the ketones were playing a major role. As with methyl isobutyl ketone, ²¹¹At extraction into 3-octanone appears to be similar to that of 1-octanol in 1 M HNO₃, while the D-values increase by a factor of roughly 1.2× and 1.8× when the HNO₃ concentration is increased to 2 and 3 M, respectively. Again, the ²⁰⁷Bi remained in the aqueous phase (D-value ≤0.05). The enhanced extraction of AtO⁺ by ketones over alcohols has also been demonstrated by employing DFT calculations, which showed the free energy of binding for acetone to be 4.6 kcal mol⁻¹ stronger than that for isopropyl alcohol.

The overall behavior of ²¹¹At extraction in both the 3-octanone and methyl isobutyl ketone systems was similar, showing a linear relationship between ²¹¹At D-values and the initial HNO₃ concentration in the aqueous phase between 1-3 M HNO₃, while the slope of the methyl isobutyl ketone system was roughly 50% steeper than that of the 3-octanone system. The direct correlation between D-values of ²¹¹At into both methyl isobutyl ketone and 3-octanone as a function of HNO₃ concentration may indicate an interaction between the ketone and At metal center. Currently, the nature of such an interaction is not completely clear. Density functional calculations show a strong donor-acceptor interaction between the empty π* orbital of the AtO⁺ and the ‘sp²’ O lone pair of the acetone. The NBO analysis of the AtO+_isopropanol indicates its sp^{a} O lone pair donates 0.11 fewer electrons to AtO⁺ than the sp² O lone pair orbital in AtO+_acetone. This interaction is 4.6 kcal:mol stronger than the corresponding interaction of the AtO⁺ with the ‘sp³’ O lone pair of isopropyl alcohol, while the solvent corrected Gibbs free energy of binding is still larger for AtO⁺_acetone than for AtO⁺_isopropanol by 2.1 kcal/mol. Thus, ketones show strong binding to AtO⁺, which leads to better extraction. At the H₂O-organic, interface, the organic molecules will have their polar end (oxygen) in (at) the H₂O layer. The AO⁺ and NO₃⁻ will be solvent separated in the H₂O layer so the early interaction of these species with respect to extraction of AtO⁺ will be the binding of AtO⁺ with the oxygen of the organic molecule. The movement of the AtO⁺ into the organic layer will necessarily need to be accompanied by the NO₃⁻.

Extraction Chromatography:

Amberchrom® CG300M porous beads with a pore volume of 0.7 mL g⁻¹ and a particle size of 50-100 μm slurry in 20% ethanol was purchased from Sigma-Aldrich. Amberchrom® CG300M is a styrene-divinylbenzene copolymer with no functional group on the benzene ring. Prior to use, the beads were dried at 80° C. for a minimum of 24 h to remove any solvent from the pores. The dried resin was then impregnated with either 1-octanol or 3-octanone by soaking the beads in the organic solvent for no less than 24 h. Thermogravimetric analysis (TGA) was performed on the impregnated resin, as well as the dried resin, using a TA Instruments TGA 5500 at a heating rate of 10° C. min⁻¹ under N₂ flow. The impregnated resin was then packed into a 2-mL Kontes® Flex-Column® with a bed volume (BV) of 0.5 mL and an inner diameter (ID) of 0.7 cm. An excess of organic solvent was maintained in the column above the bed of the impregnated resin to prevent evaporation of the solvent from the pores Immediately before the extraction chromatographic separation, the excess solvent was drained from the column.

The general chromatography procedure is as follows. The load solution, a 0.5-5 mL solution spiked with 13±1.3 μCi to 9.8±0.98 mCi of ²¹¹At in 2-6 M HNO₃, was passed through the column in 0.5 mL aliquots, next four 0.5-mL aliquots of 2 M HNO₃ were passed through the column, followed by a 0.5-mL aliquot of H₂O, and finally three to five 0.5-mL aliquots of ethanol. The elution of each fraction was expedited by manually applying pressure to the headspace of the column with a syringe. In all cases, fractions were collected every 0.5 mL and each fraction was analyzed by γ-ray spectroscopy. Total organic carbon analysis (TOC) using a Shimadzu TOC-VWP analyzer was conducted on fractions eluted from a column packed with 3-octanone impregnated resin (BV ˜0.5 mL) following the general chromatography procedure; however, no radioactive species were present.

Column Characterization:

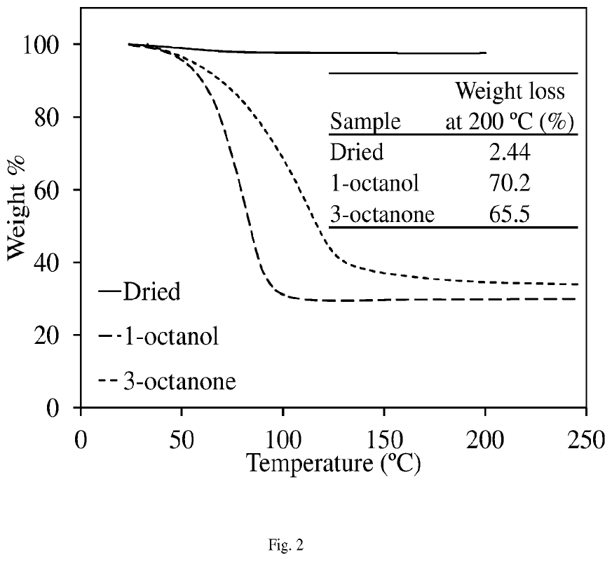

The loading of the impregnated Amberchrom® CG300M resin with either 1-octanol or 3-octanone was determined by TGA, as shown in FIG. 2. The dried, unimpregnated resin showed very little weight loss, 2.44%, upon heating to 200° C., indicating only surface H₂O sorbed from the atmosphere. The low mass percent from water is not surprising, as Amberchrom® CG300M is hydrophobic in nature, having phenyl functional groups dangling into the pore space. The impregnated resin, on the other hand, had much larger weight loss at 200° C., 70.2% for the 1-octanol and 65.5% for the 3-octanone. This indicates that the pores have been filled with the organic solvents. However, the low temperature required to remove the solvents, due to the relatively low boiling points and high vapor pressures (see Table 1) necessitates the beads remain submersed in the solvent until immediately prior to use.

TABLE 1
Properties for the selected organic solvents.

| Solvent | MW | BP (° C.) | ρ (g cm⁻³) | P_{Vapor} at 25° C. (kPa) |
|---|---|---|---|---|
| 1-octanol | 130.2 | 195 | 0.826 | 0.01 |
| 3-octanone | 128.2 | 166 | 0.822 | 0.29 |

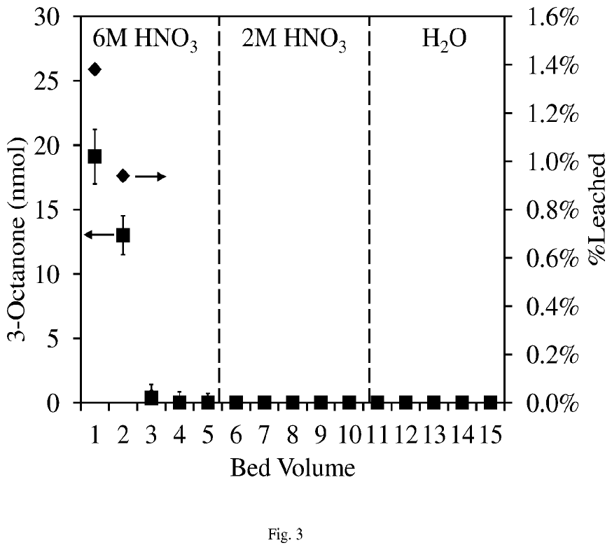

To determine if the organic solvent leached from the pores during the chromatography process, total organic carbon (TOC) analysis was performed on fractions of 6 M HNO₃, 2 M HNO₃, and H₂O eluents which had been successively passed through an extraction chromatography system packed with beads impregnated with 3-octanone to achieve a BV of 0.5 mL. FIG. 3 shows the amount of 3-octanone in each fraction and the percent leached based on the density of the beads. The density of the 3-octanone impregnated beads was calculated to be 0.90±0.05 g/mL as follows. The impregnated beads were separated from excess 3-octanone solvent by centrifugation with a Costar® Spin-X® 0.45 μm cellulose acetate centrifuge tube filter with a mini-centrifuge and weighed. A known volume of 3-octanone was then added to the beads and the volume displacement was measured and shown in the equation below.

$$ρ = \frac{m}{{V}_{F} - {V}_{I}}$$

A small amount of 3-octanone was observed in the first two fractions, 1.4% and 0.9% of the total, respectively, while the subsequent fractions were at or below baseline. The initial leaching of 3-octanone in the first two fractions of 6 M HNO₃ may be due to residual solvent in the interstitial space between beads, rather than solvent sorbed in the pores. This indicates that very little leaching of the organic solvent is removed from the pores of the resin during the extraction chromatography process. There is very little bleeding of ²¹¹At prior to intentional elution of the nuclide, which major indicates extraction of ²¹¹At into the impregnated solvent and the solvent with the extracted ²¹¹At remains in the pores. Other extraction chromatography systems which are based on silica scaffolding show a higher tendency toward leaching of the organic phase and require the addition of multicomponent solvent systems to improve the hydrophobic character of the stationary phase.

Extraction Chromatography:

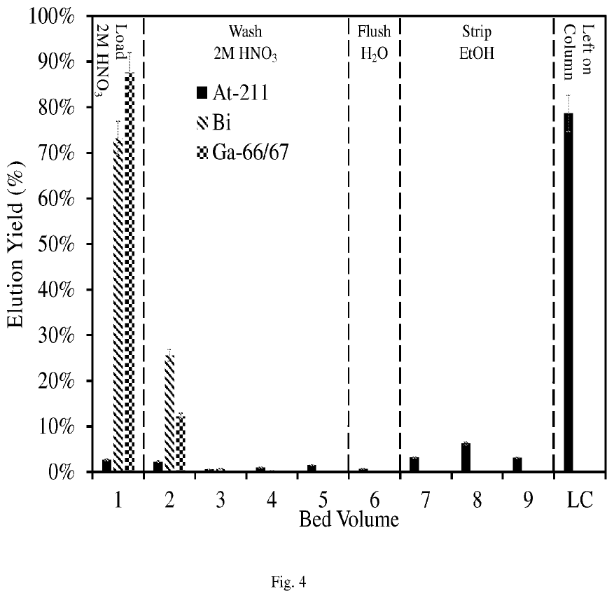

In order for ²¹¹At to be utilized in a pharmaceutical setting, it will need to be purified from both the nonradioactive natural Bi, and any radiochemical contaminants generated in its production. As mentioned earlier, the short half-life of ²¹¹At (t_{1/2}, ˜7.2 h) necessitates rapid chemistry to achieve separation from the host matrix, Bi metal in this case. To begin with, a 1-octanol extraction chromatography system with a BV of 0.5 mL was tested with a small spike of the Run 1 dissolved bombarded target solution (˜13 μCi of ²¹¹At) in 2 M HNO₃. As shown in the chromatogram in FIG. 4, the ²¹¹At was nearly quantitatively extracted (≥97%) onto the column, while roughly 73% of the Bi, which has a D-value of ≤0.1 in 1-octanol, and a majority of the radiochemical contaminants were not retained, passing through the column and eluting in the load fraction. The Bi, along with the contaminant species, were further eluted in the 2 M HNO₃ wash, recovering the remainder in the first fraction of the wash. It should be noted that no attempt was made to adjust the fraction collection to correspond to the load solution front. That is to say, once the load solution was added to the top of the column, each drop eluted was collected. So, the first 200-250 μL of solution corresponded to that of the remaining solution in the free volume of the column (40-50% of the BV). This indicates that while Bi and the radiochemical contaminants were seen in the first washing fraction collected, they most likely moved through the column completely uninhibited, remaining exclusively in the original load solution. The subsequent three fractions of the 2 M HNO₃ wash were absent of any of these species. The ²¹¹At, on the other hand, remained mostly on the column, with only approximately 5% being eluted in the entire wash. As with the later wash fractions, the H₂O flush contained only trace amounts of ²¹¹At and was void of any other species of interest. It was then attempted to strip the column with ethanol, and in so doing, dissolve the organic solvent containing the extracted ²¹¹At, which would result in its elution. However, only a small fraction of the loaded ²¹¹At was eluted in any of the three stripping fractions, with a total elution yield of ca. 13% combined. The majority of the ²¹¹At (˜79%) remained adhered to the porous beads, an unexpected result. While the elution yield was less than desirable, the recovered ²¹¹At product was of high purity, with complete decontamination of Bi and the other radiochemical contaminants and a decontamination factor (DF)≥10⁵.

Currently, the exact mechanism for ²¹¹At adherence to the resin is unclear, but it seems there is an interaction of AtO⁺ with the resin backbone. The Amberchrom® CG300M resin is based on a polystyrene divinylbenzene polymer. When utilized as a support for thin films of extractant ligands sorbed to the surface, as with extraction chromatography of metal ions, the backbone is thought of as inert with respect to the metal species of interest. One reason for the retention of the AtO⁺ species on the resin could be interactions of the AtO⁺ molecules to defects in the polymer, which were generated in the manufacturing of the resin. The hypothesis of the ²¹¹At interacting with defects in the polymer chain, as opposed to the bulk functionality of the resin, the phenyl group in the case of Amberchrom® CG300M, is the very small amount of ²¹¹At retained. That is to say, roughly 10 μCi of ²¹¹At was retained by the resin, which translates to 2.4×10⁻¹⁴ mol, many orders of magnitude less than the phenyl groups present. If a strong interaction occurs with the phenyl groups and ²¹¹At, the expected result would be to have near quantitative retention of the ²¹¹At. On the other hand, if some interaction with defects is occurring, these defects would only need to represent a very small fraction of the resin, <<0.01% (w/w %).

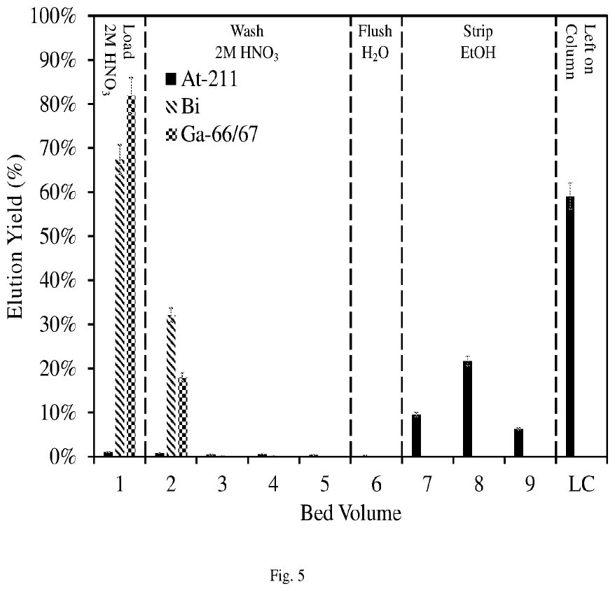

Next, a second extraction chromatography system impregnated with 3-octanone instead of 1-octanol was tested with a small spike of the Run 1 dissolved bombarded target solution (˜μCi of ²¹¹At) also in 2 M HNO₃ (see FIG. 5). The use of 3-octanone provides several advantages over 1-octanol, which includes showing enhanced ²¹¹At extraction at higher HNO₃ concentrations and being biologically benign. Much like in the 1-octanol, 3-octanone does not extract Bi, with a D-value of <0.1, and the Bi remains in the load solution, passing through the column. The radiochemical impurities also remained in the load solution and passed through the column unhindered. The ²¹¹At was extracted more strongly by the 3-octanone system, ≥99%, with minimal leaching in the wash or the flush, <3%. The elution yield of ²¹¹At in the ethanol strip increased to 37%, with nearly 22% being eluted in the second strip fraction alone. Despite this increased yield, the majority (59%) of the ²¹¹At remained on the resin. Again, it should be pointed out, despite the low yield, the purity of the product is remarkably high, with a DF of ≥10⁵. As with the 1-octanol system, the small amount of ²¹¹At, ˜7.7 μCi or 1.8×10″ mol is retained on the resin, is in line with the hypothesis of defects in the polymer chain being the source of the retention.

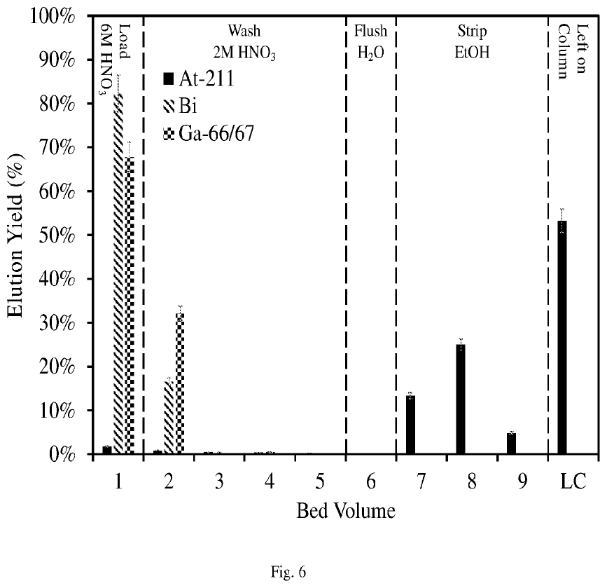

Following the increased elution yield with the 3-octanone system, the acidity of the load solution was increased to 6 M HNO₃ (chromatogram shown in FIG. 6) to determine if the acidity of the dissolution would need to be adjusted prior to scaling up the amount of ²¹¹At. As with the 2 M HNO₃ load, ²¹¹At was extracted (≥98%), while the Bi and other contaminants were not retained on the column, and moved through the column with the load solution. The ²¹¹At elution profile was comparable to that loaded in 2 M HNO₃, with approximately 25% coming off in the second strip fraction and 43% in all three, with high purity (DF ≥10⁵). A large portion of ²¹¹At was left on the resin, 53% (˜6.9 μCi or 1.6×10′ mol), presumably bound at defect sites on the polymer. While the elution yield was modest, the fact that ²¹¹At did not elute until the strip indicates that the dissolved bombarded target solution can be loaded directly without modification.

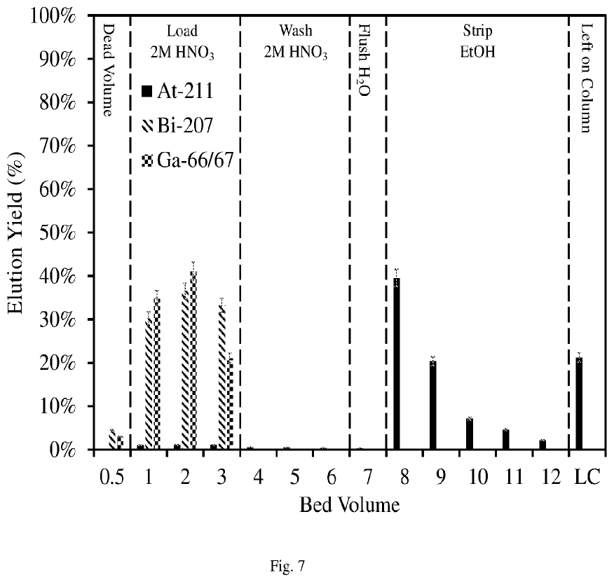

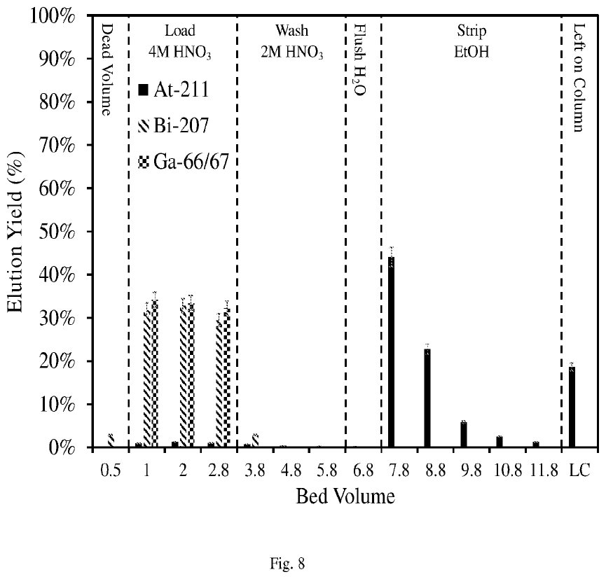

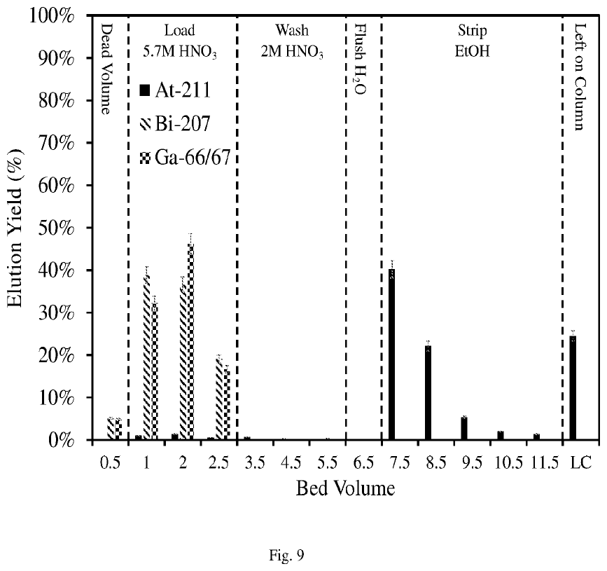

The activity of the spike was then increased to roughly 1 mCi of ²¹¹At and the elution profile of 3-octanone impregnated resin was examined as a function of nitric acid concentration. FIGS. 7-9 show the chromatograms of ²¹¹At loaded in 2, 4, and 5.7 M HNO₃, respectively. In all three cases (see Table 2), as in the previous studies, the initial loading of ²¹¹At onto the column was near quantitative, ˜97%, while the Bi and radiochemical impurities again passed through the column uninhibited. Any residual impurities were removed in the 2 M HNO₃ wash and H₂O flush. The majority of ²¹¹At (71-77%) was then eluted from the columns in the strip, with 40-44% coming off in the first fraction followed by 20-23% in the second strip fraction. One major difference from the chromatograms with only 13 μCi ²¹¹At is that upon increasing the amount of ²¹¹At, was the resin appeared to retain a smaller percentage of the loaded ²¹¹At, only 19-24% rather than the 50-59% observed in the previous studies. It should be noted, in these chromatograms, an attempt to align the collection of fractions with the solvent front was made by adjusting the collection ˜250 μL. This appears to have been a slight over estimate, as a small amount of ²⁰⁷Bi and ^{66/67}Ga was observed in the dead volume fractions.

TABLE 2
Comparison of chromatograms of a 1.5-mL aliquot of 2M HNO₃, 1.4-mL aliquot
of 4M HNO₃, and 1.3-mL aliquot of 5.7M HNO₃ containing a 399-μL spike (~1.0
mCi ²¹¹At) of the Run 2 dissolved bombarded target with a 3-octanone impregnated
Amberchrom ® CG300M resin bed (0.5-mL BV, 7 mm ID × 13 mm height).

| | 2M HNO₃ Load | | | 4M HNO₃ Load | | | 5.5M HNO₃ Load | | |
|---|---|---|---|---|---|---|---|---|---|
| Fraction | ²¹¹At | ²⁰⁷Bi | ⁶⁶Ga/⁶⁷Ga | ²¹¹At | ²⁰⁷Bi | ⁶⁶Ga/⁶⁷Ga | ²¹¹At | ²⁰⁷Bi | ⁶⁶Ga/⁶⁷Ga |
| Dead* | <0.1% | 4.4% ± | 3.0% ± | <0.1% | 2.9% ± | 0.0% ± | <0.1% | 5.1% ± | 4.8% ± |
| | | 0.2% | 0.1% | | 0.1% | 0.0% | | 0.3% | 0.2% |
| Load 1 | 1.0% ± | 30% ± | 35% ± | 1.0% ± | 32% ± | 34% ± | 1.1% ± | 39% ± | 32% ± |
| | 0.1% | 1.5% | 1.7% | 0.1% | 1.6% | 1.7% | 0.1% | 1.9% | 1.6% |
| Load 2 | 1.1% ± | 37% ± | 41% ± | 1.3% ± | 33% ± | 33% ± | 1.4% ± | 37% ± | 46% ± |
| | 0.1% | 1.8% | 2.1% | 0.1% | 1.6% | 1.7% | 0.1% | 1.8% | 2.3% |
| Load 3 | 1.1% ± | 33% ± | 21% ± | 1.0% ± | 29% ± | 32% ± | 0.6% ± | 19% ± | 17% ± |
| | 0.1% | 1.7% | 1.1% | 0.1% | 1.5% | 1.6% | 0.1% | 1.0% | 0.8% |
| Wash 1 | 0.6% ± | <0.1% | <0.1% | 0.8% ± | 2.9% ± | <0.1% | 0.7% ± | <0.1% | <0.1% |
| | 0.1% | | | 0.1% | 0.1% | | 0.1% | | |
| Wash 2 | 0.5% ± | <0.1% | <0.1% | 0.3% ± | <0.1% | <0.1% | 0.2% ± | <0.1% | <0.1% |
| | 0.1% | | | 0.1% | | | 0.1% | | |
| Wash 3 | 0.4% ± | <0.1% | <0.1% | 0.3% ± | <0.1% | <0.1% | 0.2% ± | <0.1% | <0.1% |
| | 0.1% | | | 0.1% | | | 0.1% | | |
| Flush | 0.3% ± | <0.1% | <0.1% | 0.2% ± | <0.1% | <0.1% | <0.1% | <0.1% | <0.1% |
| | 0.1% | | | 0.0% | | | | | |
| Strip 1 | 40% ± | <0.1% | <0.1% | 44% ± | <0.1% | <0.1% | 40% ± | <0.1% | <0.1% |
| | 2.0% | | | 2.2% | | | 2.0% | | |
| Strip 2 | 20% ± | <0.1% | <0.1% | 23% ± | <0.1% | <0.1% | 22% ± | <0.1% | <0.1% |
| | 1.0% | | | 1.1% | | | 1.1% | | |
| Strip 3 | 7.1% ± | <0.1% | <0.1% | 5.8% ± | <0.1% | <0.1% | 5.4% ± | <0.1% | <0.1% |
| | 0.4% | | | 0.3% | | | 0.3% | | |
| Strip 4 | 4.6% ± | <0.1% | <0.1% | 2.5% ± | <0.1% | <0.1% | 1.9% ± | <0.1% | <0.1% |
| | 0.2% | | | 0.1% | | | 0.1% | | |
| Strip 5 | 2.2% ± | <0.1% | <0.1% | 1.3% ± | <0.1% | <0.1% | 1.4% ± | <0.1% | <0.1% |
| | 0.1% | | | 0.1% | | | 0.1% | | |
| Left on | 21% ± | <0.1% | <0.1% | 19% ± | <0.1% | <0.1% | 24% ± | <0.1% | <0.1% |
| Column | 1.1% | | | 0.9% | | | 1.2% | | |

*Note:
the dead volume was assumed to be half the BV, but appears to have been an over estimate, as a small amount of ²⁰⁷Bi and ^{66/67}Ga was observed in the fraction; data were decay corrected to account for differences in half-lives.

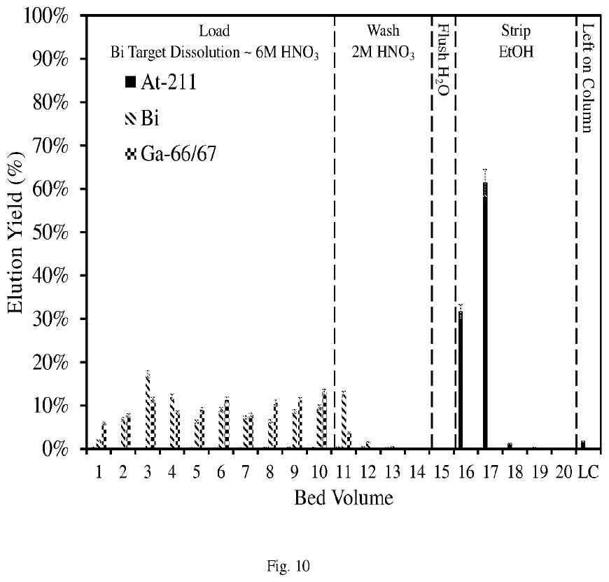

The separation was further scaled up with a 5-mL aliquot of the Run 1 dissolved target solution (˜4.1 mCi of ²¹¹At in ca. 6 M HNO₃). FIG. 10 shows the elution profile of the scaled-up separation. As with the studies containing smaller quantities of ²¹¹At, the contaminant species were not retained by the column, Bi and other undesired species were carried along in the load. Even with much greater masses, the Bi was completely removed from the column within the washing fractions. Of greater interest was the ²¹¹At elution profile in the scaled-up separation. First, ≥98% of the ²¹¹At (˜4 mCi) was loaded onto the column, with no breakthrough observed throughout the 5-mL load volume. Second, there was roughly only a 1% bleed through of the ²¹¹At during the washes and flush. Third, the majority of the ²¹¹At was eluted in the first two stripping fractions, 32% and 61%, respectively, which represents 95% of the loaded ²¹¹At, at a DF of ≥10⁵. Again, attention should be brought to the fact that for this chromatogram, no attempt was made to adjust the fraction collection to correspond to the load solution front. So the first 40-50% of solution of each fraction is the residual solution from the previous fraction, which is retained in the free volume of the column. The subsequent three strip fractions contained minimal amounts of ²¹¹At, with 1%, 0.3%, and ≤0.1%, respectively. Finally, the resin only retained a very small amount of ²¹¹At, ≤2%, which represents 82 μCi (˜1.9×10⁻¹³ mol).

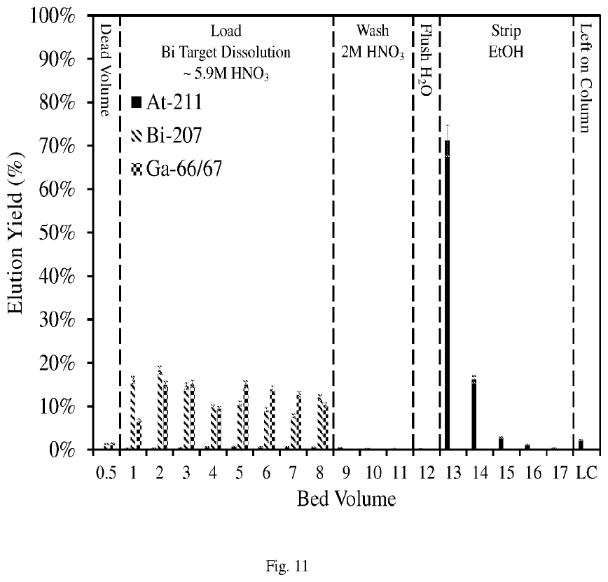

Finally, the amount of ²¹¹At was increased to approximately 9.8 mCi, as shown in FIG. 11. Following the trend observed in the 4.1 mCi of ²¹¹At separation, the Bi and other radiochemical contaminants remained in the supernatant, while the ²¹¹At was strongly retained by the column, with ˜95% loading. Very little (≤1%) bleed-through of ²¹¹At was observed in the wash and flush and did not elute until the strip, where the majority, ˜71%, was recovered in the first stripping fractions. The consecutive strip fraction contained roughly 16%, 3%, 1.2%, and ≤1% of the ²¹¹At. The DF remained high, >10⁵, for all the recovered ²¹¹At in the strip. The larger percentage in the first fraction of the strip is due to the fact the collection of fractions was adjusted to accommodate for the free column volume. Again, a small amount of ²¹¹At remained adhered to the resin, ˜2%. The behavior of ²¹¹At remains very similar upon increasing the amount from approximately 4.1 mCi (9.4×10⁻¹² mol) to 9.8 mCi (2.3×10⁻¹¹ mol), despite the total quantity more than doubling—a factor of 2.4×—the increase in the actual amount of ²¹¹At remains very small, 1.4×10⁻¹¹ mol. This leaves the other constituents in the chemical system, specifically the 3-octanone (2.3×10⁻³ mol), in much, much greater excess, roughly nine orders of magnitude. Keeping this in mind, the separation system under investigation should be able to accommodate further increases in ²¹¹At and is anticipated to be well suited for bombarded targets at the production scale of 20-100 mCi of ²¹¹At.

The speciation of the ²¹¹At in dissolution solution, mainly HNO₃; extracted in the impregnated resin, mainly 3-octanone; and eluted in the strip, primarily ethanol, has not been experimentally determined, as the small amount of At present, resulting from the short half-life, prevent traditional spectroscopic techniques from being employed. At(III), as AtO⁺, is the dominant species in the aqueous solution. A strong donor-acceptor interaction between the empty π* orbital of the AtO⁺ and the ‘sp²’ O lone pair of the ketone was calculated and is believed to be the driving force of the efficient extraction of AtO⁺ out of HNO₃ into the 3-octanone. Thus, AtO⁺ is likely the dominant species in the ethanol strip.

The entire process, from the addition of the first 0.5-mL load aliquot to eluting the fifth and last strip fraction, took less than 20 min despite the slow nature of manual addition of eluent and collection of fractions. Supposing the solutions were fed through the column with a pump, set to the modest speed of 2 mL min⁻¹, the process of recovering ≥95% of the ²¹¹At would take less than 5 min. As was discussed earlier, the source of the affinity between the AtO⁺ and the resin is currently unknown, which prevents a detailed description being given for why the scaled-up separation yield was much higher than its smaller counterpart. However, if the conjecture that an interaction with defects in the resin is occurring, it is not unreasonable to conclude all the exposed defect sites on the resin were saturated in the scaled-up separation. Once the sites were saturated, the majority of the ²¹¹At was extracted into the solvent filling the pores, which was eluted by dissolving the 3-octanone into the ethanol strip. This process of recovering high purity ²¹¹At, in near quantitative yields, directly from nitric acid represents a significant advance in At separations.

1. A process comprising
(a) contacting a composition comprising astatine and bismuth with nitric acid to form a first solution comprising astatine, bismuth, and nitric acid;
(b) contacting a resin with the first solution so that astatine partitions out of the first solution and into the resin; and
(c) eluting astatine from the resin.

2. The process of claim 1, wherein the resin is impregnated with a solvent.

3. The process of claim 2, wherein the solvent comprises an organic solvent.

4. The process of claim 3, wherein the organic solvent is polar.

5. The process of claim 3, wherein the organic solvent comprises an optionally substituted C₁-C₁₈ alkyl.

6. The process of claim 5, wherein the organic solvent comprises a carbonyl.

7. The process of claim 5, wherein the organic solvent comprises an aldehyde, a ketone, an ester, an amide, a carbonate, a carboxylate, or a carbamate.

8. The process of claim 5, wherein the organic solvent is of the formula C₁-C₆ alkyl-C(O)—C₁-C₆ alkyl, wherein each hydrogen atom in C₁-C₆ alkyl is optionally substituted.

9. The process of claim 3, wherein the organic solvent is octanone.

10. The process of claim 3, wherein the organic solvent is 3-octanone.

11. The process of claim 3, wherein the organic solvent is a C₁-C₁₈ alkanol.

12. The process of claim 3, wherein the astatine has a D-value partition coefficient in the organic solvent of at least 20.

13. The process of claim 3, wherein the astatine has a D-value partition coefficient in the organic solvent at least 40.

14. The process of claim 3, wherein the astatine has a D-value partition coefficient in the organic solvent at least 60.

15. The process of claim 3, wherein the astatine has a D-value partition coefficient in the organic solvent at least 80.

16. The process of claim 1, wherein the resin is an inert resin.

17. The process of claim 1, wherein the resin is a polymeric resin, a zeolite, a molecular sieve, or a porous glass bead.

18. The process of claim 1, wherein the resin comprises a styrene-divinylbenzene copolymer.

19. The process of claim 18, wherein the benzene does not contain a functional group.

20. The process of claim 1, wherein the astatine is ²¹¹At.

21.-66. (canceled)
